(19) United States
(12) Patent Application Publication
(10) Pub. No.: US 2025/0365376 A1
(43) Pub. Date: Nov. 27, 2025

(54) IMAGE FORMING SYSTEM, CONTROL METHOD FOR CONTROLLING IMAGE FORMING SYSTEM, AND STORAGE MEDIUM

(71) Applicant: CANON KABUSHIKI KAISHA, Tokyo (JP)

(72) Inventor: KOSUKE TSUJITA, Tokyo (JP)

(21) Appl. No.: 19/214,769

(22) Filed: May 21, 2025

(30) Foreign Application Priority Data
May 27, 2024 (JP) 2024-085521

(51) Int. Cl. H04N 1/00; B65H 43/06

(52) U.S. Cl. CPC H04N 1/0049; B65H 43/06; H04N 1/00037; B65H 2551/20

(57) ABSTRACT

An image forming system includes a plurality of sheet discharge apparatuses, each including at least one light-emitting section, and a control unit configured to, under a condition that the number of sheets discharged to a certain sheet discharge apparatus among the plurality of sheet discharge apparatuses reaches a threshold, control the at least one light-emitting section included in each of the plurality of sheet discharge apparatuses to light up.

### BACKGROUND

### Field of the Disclosure

The present disclosure relates to an image forming system, a control method for controlling an image forming system, and a storage medium.

### Description of the Related Art

Conventionally, an image forming apparatus presents information regarding error events including a jam, an out-of-paper state, and a trayful state using various notification units and display units. Specifically, a message is displayed on an operation section, or a lamp is attached to the image forming apparatus, and information regarding the occurrence of an error event and the type of the error event is presented based on the lighting of the lamp and the lighting color of the lamp. Moreover, a printing status is displayed on the operation section, and an operator is caused to visually confirm when sheet discharge destinations will be full.

Japanese Patent Application Laid-Open No. 2011-201676 discusses a printing apparatus including an image forming unit that creates a print product by forming an image on a sheet, a plurality of storage sections that stores print products created by the image forming unit, and a sorting unit that discharges print products to different storage sections according to group. The printing apparatus includes a determination unit that determines whether the printing apparatus is in a near-full state close to the state where print products are stored in all the plurality of storage sections.

Error events that occur in the image forming apparatus vary, and portions where errors occur in the image forming apparatus also cover a sheet feeding/discharge apparatus and a conveyance path included in the image forming apparatus. On the other hand, in the conventional art, only an image forming apparatus includes an operation section and a lamp and notifies a user of an error based on a display on the operation section and the lighting of the lamp, and therefore, the following issue exists.

First, the lamp uses a simple information provision method, and therefore cannot notify the user of a complex event. In other words, the lamp only presents information regarding the occurrence of an error and the severity of the error (an error or a warning that has stopped the apparatus). Thus, the lamp cannot provide information regarding which part of the image forming apparatus an error event has occurred in and what the content of the error event is.

Second, while the operation section can present abundant information, the operation section requires an operator attempting to acquire information to move to the location where the operation section is installed to obtain the information. That is, to obtain information regarding the location where an error has occurred in the apparatus and the content of the error, the operator needs to move to the place where the operation section is installed each time.

Neither of the information presentation units in the conventional art is efficient as a unit that presents the place of an error event that occurs in the image forming apparatus and information regarding the error event. Thus, an effective unit for the efficient use of the image forming apparatus is not provided to the operator.

### SUMMARY

In some embodiments, an image forming system includes a plurality of sheet discharge apparatuses, each including at least one light-emitting section, and a control unit configured to, under a condition that the number of sheets discharged to a certain sheet discharge apparatus among the plurality of sheet discharge apparatuses reaches a threshold, control the at least one light-emitting section included in each of the plurality of sheet discharge apparatuses to light up.

Further features of various embodiments will become apparent from the following description of exemplary embodiments with reference to the attached drawings.

### BRIEF DESCRIPTION OF THE DRAWINGS

FIG. 1 is a diagram illustrating an example of a configuration of a printing system.

FIG. 2A is a block diagram illustrating an example of a configuration of a digital front end (DFE).

FIG. 2B is a block diagram illustrating an example of a configuration of a printer.

FIG. 3A is a diagram illustrating an example of a configuration of each of sheet feeding sections included in the printer.

FIG. 3B is a diagram illustrating an example of a configuration of an image forming section included in the printer.

FIG. 3C is a diagram illustrating examples of configurations of first and second fixing sections, a cooling section, and a reverse section.

FIG. 3D is a diagram illustrating examples of configurations of sheet discharge sections included in the printer.

FIG. 4 is a diagram illustrating shapes and placement of conveyance sections of the printer.

FIG. 5 is a diagram illustrating an image of storage of jobs in a queue.

FIG. 6 is a diagram illustrating a table that stores analyzed statuses of the jobs stored in the queue.

FIG. 7A is a diagram illustrating a management table that manages a stacking status and warning conditions with respect to each sheet discharge destination.

FIGS. 7B and 7C are diagrams illustrating warning light color management tables.

FIG. 8 is a diagram illustrating an example of a schedule screen.

FIGS. 9A-1 and 9A-2 are a flowchart illustrating control of an alert light and light-emitting diodes (LEDs) by the DFE.

FIG. 9B is a flowchart illustrating control of the alert light and the LEDs by the printer.

FIG. 10 is a diagram illustrating an example of a setting screen.

FIG. 11 is a diagram illustrating extinction and lighting of LEDs of multiple connected sheet discharge apparatuses.

### DESCRIPTION OF THE EMBODIMENTS

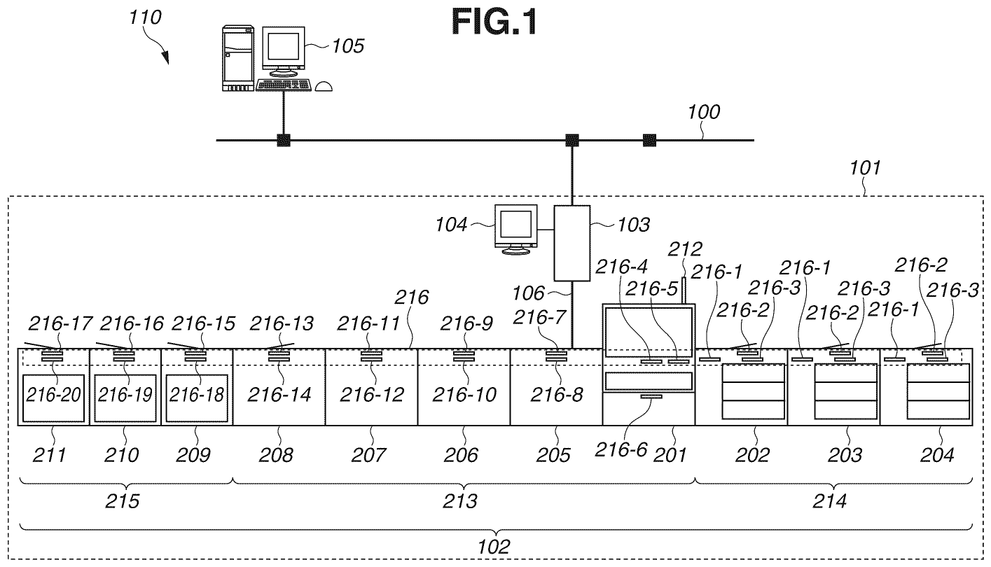

FIG. 1 is a diagram illustrating an example of the configuration of a printing system 110 according to the present exemplary embodiment. The printing system 110 includes a network 100, an image forming apparatus 101, and a personal computer (PC) 105.

In the present exemplary embodiment, a printer 102 using an inkjet method is described as an example of the image forming apparatus 101, and the PC 105 is described as an example of an information processing apparatus. The image forming apparatus 101 and the PC 105 are connected together via the network 100 so that the image forming apparatus 101 and the PC 105 can communicate with each other.

FIG. 1 illustrates a case where a single information processing apparatus is provided in the printing system 110. However, the image forming apparatus 101 and a plurality of information processing apparatuses may be connected together via the network 100 so that the image forming apparatus 101 and the plurality of information processing apparatuses can communicate with each other. FIG. 1 illustrates a case where the printing system 110 according to the present exemplary embodiment includes the image forming apparatus 101 and the information processing apparatus. The printing system 110, however, is not limited to this. For example, the image forming apparatus 101 may be the printing system 110. Further, a configuration may be employed in which in an image forming process that can be executed by the image forming apparatus 101 alone, such as the printing of a saved job, the information processing apparatus connected to the network 100 is unnecessary.

First, the PC 105 is described. The PC 105 can execute various programs, such as an application program that submits a print job. On the PC 105, various applications, such as a printer driver having the function of converting print data into a printer language corresponding to the image forming apparatus 101 and workflow software, are installed. A user who wishes to perform printing can give a print instruction from the various applications. The printer driver and the workflow software can convert data output from an application based on a print instruction into print data that can be interpreted by the image forming apparatus 101 and can transmit the print data to the image forming apparatus 101 connected to the network 100.

Although in the present exemplary embodiment, the PC 105 is illustrated as an example of the information processing apparatus, the information processing apparatus may be a mobile information terminal such as a smartphone or a tablet terminal. The method for transmitting the print data to the image forming apparatus 101 can be appropriately modified. The PC 105 may transmit the print data to the image forming apparatus 101 via a printing application or driver, or the PC 105 may transmit the print data to the image forming apparatus 101 via a cloud server.

The image forming apparatus 101 includes a printer 102, a digital front end (DFE) 103, a display section 104, and a second network 106.

Next, the printer 102 is described. The printer 102 has a print function for printing an image on a sheet. The printer 102 also has post-processing functions for aligning a plurality of sheets and dividing the discharge destination of the plurality of sheets into a plurality of trays. Examples of the sheet include various sheets such as plain paper, thick paper, and coated paper.

Although in the present exemplary embodiment, a printer using an inkjet method is used as an example of the printer 102, the printer 102 does not need to be limited to this method. The printer 102 may be a printer that uses an electrophotographic method. Further, the printer 102 may be a multifunction peripheral-type printer including a reading apparatus such as a scanner.

FIG. 1 illustrates an example where the image forming apparatus 101 has a configuration in which the DFE 103 including the display section 104 is connected to the printer 102 via the second network 106. Further, FIG. 1 illustrates an example of a form in which the printer 102 is connected to the network 100 via the DFE 103. That is, in the form illustrated in FIG. 1, the printer 102 receives an instruction to execute a print job from the PC 105 as the information processing apparatus via the DFE 103. The DFE 103 and the printer 102 are connected together via the network 106 and transmit and receive information, such as print data, various commands, and a status notification, to and from each other via the network 106.

The printer 102 is configured so that apparatuses having a plurality of different roles are linked to each other and can perform complex sheet processing. Components included in the printer 102 are described below.

Based on image data, a printer section 213 forms (prints) an image using ink on a medium (a sheet) fed from a sheet feeding unit 214 and fixes and dries the image. The printer section 213 further includes an image forming section 201, a first fixing section 205, a second fixing section 206, a cooling section 207, and a reverse section 208. The configuration and the operating principle of the image forming section 201 among these are as follows.

Inkjet heads for respective colors linearly arranged in a direction perpendicular to a conveyance direction discharge droplets from above onto a sheet conveyed to a portion below the inkjet heads according to image data, thereby forming an image on the sheet. At this time, to improve the landing properties and the fixability of the droplets, the inkjet heads discharge a primer to the sheet ahead of the discharge of the ink of the respective colors. The image forming section 201 illustrated in FIG. 1 performs an image forming process on yellow (Y), magenta (M), cyan (C), and black (K) colors. A configuration may be employed in which an image can be formed using ink of any color termed a spot color or ink of colors such as orange, violet, and green as ink of additional colors in addition to these colors.

The sheet on which a full-color image is formed in this manner is conveyed to the first fixing section 205 and the second fixing section 206. Each of the first fixing section 205 and the second fixing section 206 has a heat source such as a heater built-in. The first fixing section 205 and the second fixing section 206 dry the ink on the sheet on which the image is formed by heat, thereby fixing the image on the sheet. Next, to decrease the temperature of the heated sheet, the sheet is guided to the cooling section 207 and cooled.

The reverse section 208 is a module used to reverse the direction of the sheet and convey the sheet to the image forming section 201 again to form an image on the back side of the sheet.

The sheet feeding unit 214 continuously supplies sheets as targets on which images are to be formed by the printer section 213. FIG. 1 illustrates the state where three feeding sections 202, 203, and 204 are connected together. A sheet discharge unit 215 is a unit that accumulates printed final products. The example in FIG. 1 illustrates the state where three sheet discharge sections 209, 210, and 211 are connected together.

An alert light 212 is an informing unit that notifies an operator of the status of the printer 102 by lighting a lamp. In the printing system 110 in FIG. 1, the alert light 212 is controlled by the DFE 103.

The above components included in the printer 102 include light-emitting diodes (LEDs) 216. The printer 102 according to the present exemplary embodiment is configured so that each LED 216 can distinguishably indicate the occurrence of an event in a component in which the LED 216 is placed based on, for example, the lighting of the LED 216 and the color of the LED 216 when the LED 216 lights up.

Specifically, as a first example, a case is assumed where a jam of a sheet guided to the second fixing section 206 occurs in the second fixing section 206. In this case, in the printing system 110 according to the present exemplary embodiment, LEDs 216-9 and 216-10 included in the second fixing section 206 light up in red. This can present to the operator the occurrence of an event that makes it difficult to continue the printing due to a jam that has occurred in the second fixing section 206.

A second example is as follows. In a case where sheets run out during the printing of a job in a printing state in the sheet feeding section 202, 203, or 204 and the processing cannot be continued, it is possible to present this state to the operator by lighting an LED 216-3 included in the sheet feeding section 202, 203, or 204 in red.

A third example is as follows. In a case where the stacking amount of sheets reaches a predetermined amount and no more sheets can be stacked during the printing of a job in a printing state in the sheet discharge section 209, 210, or 211, it is possible to present this state to the operator by lighting an LED 216-15, 216-16, or 216-17 included in the sheet discharge section 209, 210, or 211, respectively, in red.

The display section 104 included in the DFE 103 or the alert light 212 can also present information equivalent to the information presented by these LEDs 216. However, to determine in which unit among many units included in the printer 102 an event has occurred and what the event that has occurred is, the operator needs to move to the place where the display device 104 is installed, and the operator needs to confirm the content of the information displayed on the display device 104.

On the other hand, based on the LEDs 216 according to the present exemplary embodiment, a unit in which an event has occurred is identified by selectively lighting an LED 216 included in the unit for display, and the type of the event that has occurred can also be identified based on the lighting color. As described above, the LEDs 216 make it easy for the operator to comprehend an event, and it is possible to improve the operability and the convenience of the apparatus by this method.

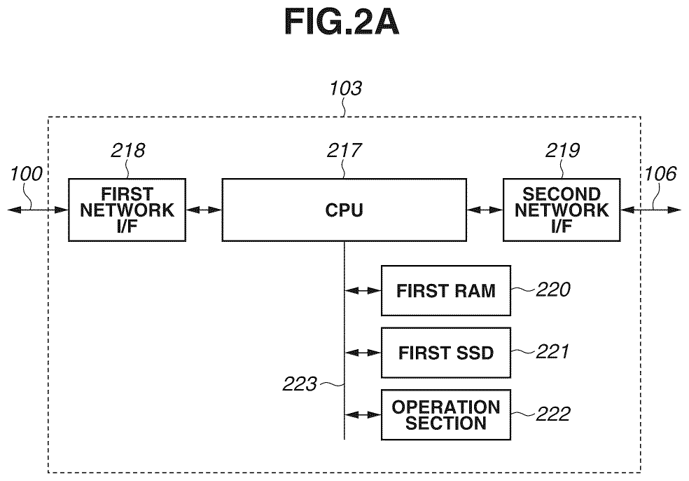

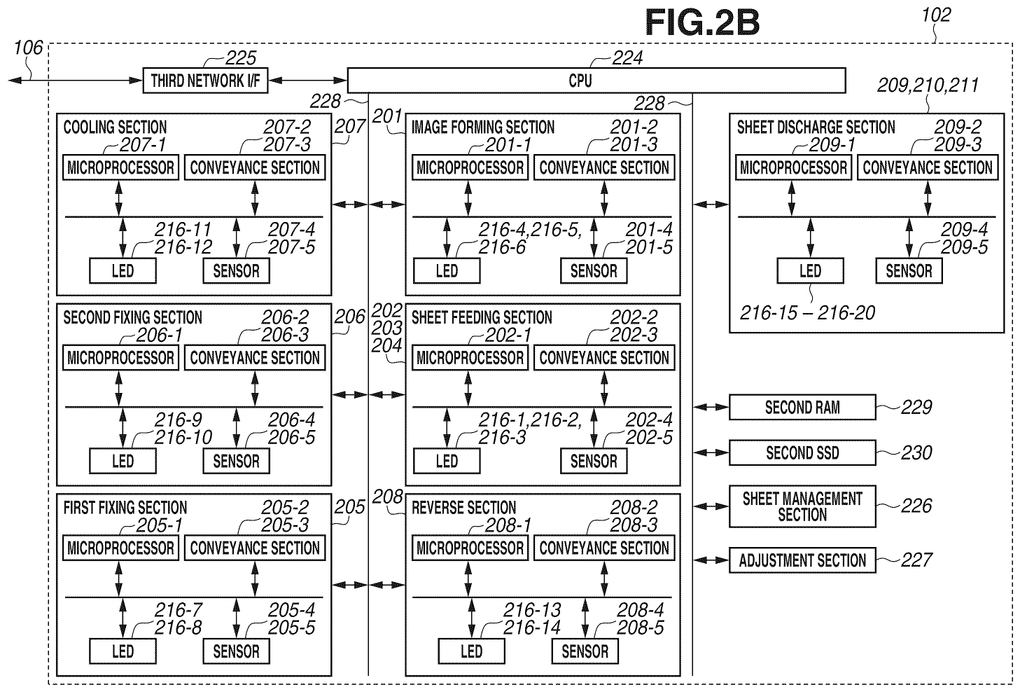

FIGS. 2A and 2B are block diagrams illustrating an example of the configuration of the image forming apparatus 101 according to the present exemplary embodiment. Blocks illustrated in FIGS. 2A and 2B are divided into units as a system, and therefore, there are portions that do not necessarily correspond to the units of the device configuration illustrated in FIG. 1. With reference to the block diagrams, examples of the internal configurations of the DFE 103 and the printer 102 included in the image forming apparatus 101 are described below.

FIG. 2A is a block diagram illustrating an example of the configuration of the DFE 103. The DFE 103 includes a central processing unit (CPU) 217, a first network interface (I/F) 218, a second network I/F 219, a first random-access memory (RAM) 220, a first solid-state drive (SSD) 221, an operation section 222, and a system bus 223.

The first network I/F 218 is used to receive print job data transmitted from the information processing apparatus such as the PC 105 connected to the network 100 or distribute the status of the image forming apparatus 101 to an external apparatus. The print job data received via the first network I/F 218 is processed by the CPU 217 reading various programs stored in the first SSD 221 into the first RAM 220 and executing the various programs.

Specific examples of this process correspond to a series of processes regarding the print job, such as the rasterization of the print job data, a raster image processor (RIP) process, an image conversion process, and a color conversion process.

The DFE 103 includes an operation section 222. The operator gives instructions to execute various settings of the DFE 103, the setting of the job, and the adjustment of the image forming apparatus 101 through the operation section 222. The CPU 217 and these modules are connected to each other via the system bus 223.

The print job data processed by the DFE 103 is transmitted from the second network I/F 219 to the printer 102 connected to the DFE 103 via the second network 106.

FIG. 2B is a block diagram illustrating an example of the configuration of the printer 102. The printer 102 includes the image forming section 201, the sheet feeding sections 202 to 204, the first fixing section 205, the second fixing section 206, the cooling section 207, the reverse section 208, and the sheet discharge sections 209 to 211. Further, the printer 102 includes a CPU 224, a third network I/F 225, a sheet management section 226, an adjustment section 227, a system bus 228, a second RAM 229, and a second SSD 230.

The third network I/F 225 is connected to the second network I/F 219 included in the DFE 103 via the second network 106 and is mainly used to receive print job data or to transmit and receive a status and a command between the DFE 103 and the printer 102.

The CPU 224 is a unit that controls these sub-modules included in the printer 102 illustrated in FIG. 2B and governs the operation of the entirety of the image forming apparatus 101. The sub-modules are connected to the CPU 224 via the system bus 228.

Although in the present exemplary embodiment, an example is illustrated where the CPU 224 is a component different from the CPU 217 included in the DFE 103, a configuration may be employed in which the DFE 103 and the printer 102 are controlled by the same CPU. The CPU 224 executes various processes by reading various programs stored in the second SSD 230 into the second RAM 229 and executing the various programs.

The sheet management section 226 is a database forming a sheet library included in the printer 102 and holds parameters of various media. The adjustment section 227 is a module that controls units for executing various calibrations and various sensors.

To the CPU 224, in addition to the above, the cooling section 207, the first fixing section 205, the second fixing section 206, the image forming section 201, the sheet feeding sections 202, 203, and 204, the reverse section 208, and the sheet discharge sections 209, 210, and 211 are also similarly connected via the system bus 228.

The internal configuration of the cooling section 207 is described below. The cooling section 207 includes a microprocessor 207-1, an upper conveyance section 207-2, a lower conveyance section 207-3, an upper sheet passage sensor 207-4, a lower sheet passage sensor 207-5, and LEDs 216-11 and 216-12.

The microprocessor 207-1 is configured to control sub-units included in the cooling section 207, and the microprocessor 207-1 and the CPU 224 are also configured to notify each other of a control command and a status.

The upper conveyance section 207-2 and the lower conveyance section 207-3 are sheet conveyance units included in the cooling section 207, and conveyance processes by these units are controlled by the microprocessor 207-1.

The upper sheet passage sensor 207-4 and the lower sheet passage sensor 207-5 are sheet passage sensors provided in upstream portions of the upper conveyance section 207-2 and the lower conveyance section 207-3, respectively, and determine the presence or absence of a conveyed sheet. The upper sheet passage sensor 207-4 and the lower sheet passage sensor 207-5 are mainly used for a detection process for detecting a jam that has occurred in the conveyance sections 207-2 and 207-3, respectively, in the cooling section 207.

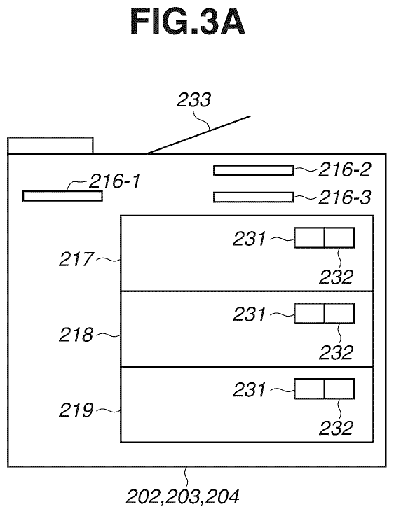

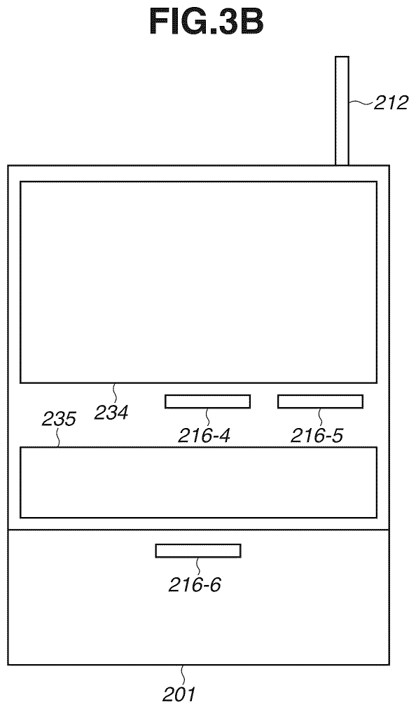

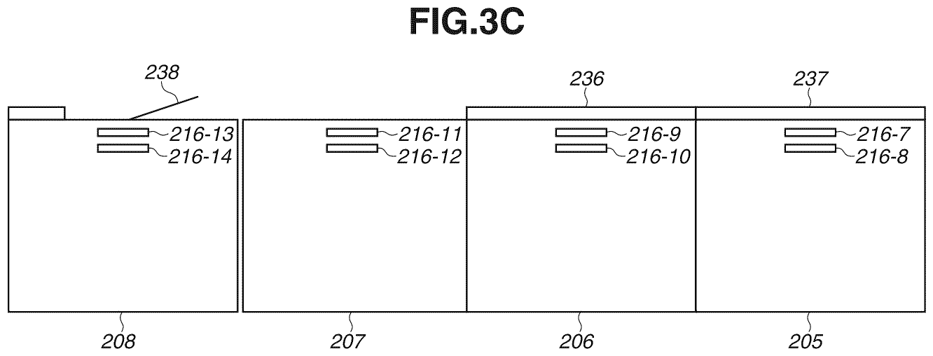

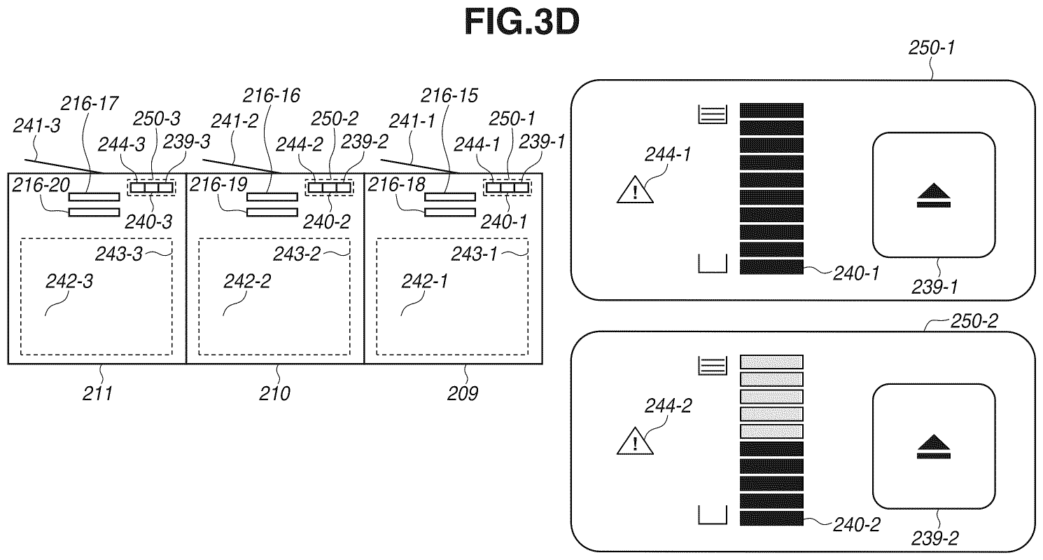

The LEDs 216-11 and 216-12 are informing units included in the cooling section 207. The LEDs 216-11 and 216-12 indicate the position and the content of an event that has occurred in the cooling section 207 based on the positions and the colors of the LEDs 216-11 and 216-12. The details of which of the LEDs 216-11 and 216-12 lights up in which color when which event occurs will be described below with reference to FIG. 3C.

The internal configuration of the first fixing section 205 is described below. The first fixing section 205 includes a microprocessor 205-1, an upper conveyance section 205-2, a lower conveyance section 205-3, an upper sheet passage sensor 205-4, a lower sheet passage sensor 205-5, and LEDs 216-7 and 216-8.

The microprocessor 205-1 is configured to control sub-units included in the first fixing section 205, and the microprocessor 205-1 and the CPU 224 are also configured to notify each other of a control command and a status.

The upper conveyance section 205-2 and the lower conveyance section 205-3 are sheet conveyance units included in the first fixing section 205, and conveyance processes by these units are controlled by the microprocessor 205-1.

The upper sheet passage sensor 205-4 and the lower sheet passage sensor 205-5 are sheet passage sensors provided in upstream portions of the upper conveyance section 205-2 and the lower conveyance section 205-3, respectively, and determine the presence or absence of a conveyed sheet. The upper sheet passage sensor 205-4 and the lower sheet passage sensor 205-5 are mainly used for a detection process for detecting a jam that has occurred in the conveyance sections 205-2 and 205-3, respectively, in the first fixing section 205.

The LEDs 216-7 and 216-8 are informing units included in the first fixing section 205. The LEDs 216-7 and 216-8 indicate the position and the content of an event that has occurred in the first fixing section 205 based on the positions and the colors of the LEDs 216-7 and 216-8. The details of which of the LEDs 216-7 and 216-8 lights up in which color when which event occurs will be described below.

The internal configuration of the second fixing section 206 is described below. The second fixing section 206 includes a microprocessor 206-1, an upper conveyance section 206-2, a lower conveyance section 206-3, an upper sheet passage sensor 206-4, a lower sheet passage sensor 206-5, and LEDs 216-9 and 216-10.

The microprocessor 206-1 is configured to control sub-units included in the second fixing section 206, and the microprocessor 206-1 and the CPU 224 are also configured to notify each other of a control command and a status.

The upper conveyance section 206-2 and the lower conveyance section 206-3 are sheet conveyance units included in the second fixing section 206, and conveyance processes by these units are controlled by the microprocessor 206-1.

The upper sheet passage sensor 206-4 and the lower sheet passage sensor 206-5 are sheet passage sensors provided in upstream portions of the upper conveyance section 206-2 and the lower conveyance section 206-3, respectively, and determine the presence or absence of a conveyed sheet. The upper sheet passage sensor 206-4 and the lower sheet passage sensor 206-5 are mainly used for a detection process for detecting a jam that has occurred in the conveyance sections 206-2 and 206-3, respectively, in the second fixing section 206.

The LEDs 216-9 and 216-10 are informing units included in the second fixing section 206. The LEDs 216-9 and 216-10 indicate the position and the content of an event that has occurred in the second fixing section 206 based on the positions and the colors of the LEDs 216-9 and 216-10. The details of which of the LEDs 216-9 and 216-10 lights up in which color when which event occurs will be described below.

The internal configuration of the image forming section 201 is described below. The image forming section 201 includes a microprocessor 201-1, an upper conveyance section 201-2, a lower conveyance section 201-3, an upper sheet passage sensor 201-4, a lower sheet passage sensor 201-5, and LEDs 216-4, 216-5, and 216-6.

The microprocessor 201-1 is configured to control sub-units included in the image forming section 201, and the microprocessor 201-1 and the CPU 224 are also configured to notify each other of a control command and a status.

The upper conveyance section 201-2 and the lower conveyance section 201-3 are sheet conveyance units included in the image forming section 201, and conveyance processes by these units are controlled by the microprocessor 201-1.

The upper sheet passage sensor 201-4 and the lower sheet passage sensor 201-5 are sheet passage sensors provided in upstream portions of the upper conveyance section 201-2 and the lower conveyance section 201-3, respectively, and determine the presence or absence of a conveyed sheet. The upper sheet passage sensor 201-4 and the lower sheet passage sensor 201-5 are mainly used for a detection process for detecting a jam that has occurred in the conveyance sections 201-2 and 201-3, respectively, in the image forming section 201.

The LEDs 216-4, 216-5, and 216-6 are informing units included in the image forming section 201. The LEDs 216-4, 216-5, and 216-6 indicate the position and the content of an event that has occurred in the image forming section 201 based on the positions and the colors of the LEDs 216-4, 216-5, and 216-6. The details of which of the LEDs 216-4, 216-5, and 216-6 lights up in which color when which event occurs will be described below.

The internal configurations of the sheet feeding sections 202, 203, and 204 are described below. Each of the sheet feeding sections 202, 203, and 204 includes a microprocessor 202-1, an upper conveyance section 202-2, a lower conveyance section 202-3, an upper sheet passage sensor 202-4, a lower sheet passage sensor 202-5, and LEDs 216-1, 216-2, and 216-3.

The microprocessor 202-1 is configured to control sub-units included in the sheet feeding section 202, 203, or 204, and the microprocessor 202-1 and the CPU 224 are also configured to notify each other of a control command and a status.

The upper conveyance section 202-2 and the lower conveyance section 202-3 are sheet conveyance units included in the sheet feeding section 202, 203, or 204, and conveyance processes by these units are controlled by the microprocessor 202-1.

The upper sheet passage sensor 202-4 and the lower sheet passage sensor 202-5 are sheet passage sensors provided in upstream portions of the upper conveyance section 202-2 and the lower conveyance section 202-3, respectively, and determine the presence or absence of a conveyed sheet. The upper sheet passage sensor 202-4 and the lower sheet passage sensor 202-5 are mainly used for a detection process for detecting a jam that has occurred in the conveyance sections 202-2 and 202-3, respectively, in the sheet feeding section 202, 203, or 204.

The LEDs 216-1, 216-2, and 216-3 are informing units included in the sheet feeding section 202, 203, or 204. The LEDs 216-1, 216-2, and 216-3 indicate the position and the content of an event that has occurred in the sheet feeding section 202, 203, or 204 based on the positions and the colors of the LEDs 216-1, 216-2, and 216-3. The details of which of the LEDs 216-1, 216-2, and 216-3 lights up in which color when which event occurs will be described below.

The internal configuration of the reverse section 208 is described below. The reverse section 208 includes a microprocessor 208-1, an upper conveyance section 208-2, a lower conveyance section 208-3, an upper sheet passage sensor 208-4, a lower sheet passage sensor 208-5, and LEDs 216-13 and 216-14.

The microprocessor 208-1 is configured to control sub-units included in the reverse section 208, and the microprocessor 208-1 and the CPU 224 are also configured to notify each other of a control command and a status.

The upper conveyance section 208-2 and the lower conveyance section 208-3 are sheet conveyance units included in the reverse section 208, and conveyance processes by these units are controlled by the microprocessor 208-1.

The upper sheet passage sensor 208-4 and the lower sheet passage sensor 208-5 are sheet passage sensors provided in upstream portions of the upper conveyance section 208-2 and the lower conveyance section 208-3, respectively, and determine the presence or absence of a conveyed sheet. The upper sheet passage sensor 208-4 and the lower sheet passage sensor 208-5 are mainly used for a detection process for detecting a jam that has occurred in the conveyance sections 208-2 and 208-3, respectively, in the reverse section 208.

The LEDs 216-13 and 216-14 are informing units included in the reverse section 208. The LEDs 216-13 and 216-14 indicate the position and the content of an event that has occurred in the reverse section 208 based on the positions and the colors of the LEDs 216-13 and 216-14. The details of which of the LEDs 216-13 and 216-14 lights up in which color when which event occurs will be described below.

The internal configurations of the sheet discharge sections 209, 210, and 211 are described below. Each of the sheet discharge sections 209, 210, and 211 includes a microprocessor 209-1, an upper conveyance section 209-2, a lower conveyance section 209-3, an upper sheet passage sensor 209-4, a lower sheet passage sensor 209-5, and LEDs 216-15 and 216-18, 216-16 and 216-19, or 216-17 and 216-20.

The microprocessor 209-1 is configured to control sub-units included in the sheet discharge section 209, 210, or 211, and the microprocessor 209-1 and the CPU 224 are also configured to notify each other of a control command and a status.

The upper conveyance section 209-2 and the lower conveyance section 209-3 are sheet conveyance units included in the sheet discharge section 209, 210, or 211, and conveyance processes by these units are controlled by the microprocessor 209-1.

The upper sheet passage sensor 209-4 and the lower sheet passage sensor 209-5 are sheet passage sensors provided in upstream portions of the upper conveyance section 209-2 and the lower conveyance section 209-3, respectively, and determine the presence or absence of a conveyed sheet. The upper sheet passage sensor 209-4 and the lower sheet passage sensor 209-5 are mainly used for a detection process for detecting a jam that has occurred in the conveyance sections 209-2 and 209-3, respectively, in the sheet discharge section 209, 210, or 211.

The LEDs 216-15 and 216-18, the LEDs 216-16 and 216-19, and the LEDs 216-17 and 216-20 are informing units included in the sheet discharge section 209, the sheet discharge section 210, and the sheet discharge section 211, respectively. The LEDs 216-15 to 216-20 indicate the position and the content of an event that has occurred in the sheet discharge sections 209, 210, and 211 based on the positions and the colors of the LEDs 216-15 to 216-20. The details of which of the LEDs 216-15 to 216-20 lights up in which color when which event occurs will be described below.

FIGS. 3A to 3D are diagrams illustrating the details of the configurations of the units included in the printer 102.

FIG. 3A is a diagram illustrating an example of the configuration of each of the sheet feeding sections 202, 203, and 204. Each of the sheet feeding sections 202, 203, and 204 includes three trays 217, 218, and 219, and the trays 217, 218, and 219 can store sheets of different sheet types and sizes. Each of the trays 217, 218, and 219 includes a tray opening instruction unit 231 and a remaining amount display unit 232 that displays the amount of remaining sheets stored inside the tray. An escape tray 233 is a tray to which a sheet in which a failure such as a folded state or a multi-fed state potentially occurs is discharged so that a folded sheet or multi-fed sheets are not conveyed to the image forming section 201.

Each of the sheet feeding sections 202, 203, and 204 includes the three LEDs 216-1, 216-2, and 216-3.

The LED 216-1 is a unit that, in a case where a jam occurs in the lower conveyance section 202-3 in the sheet feeding section 202, 203, or 204, notifies the operator of this state by lighting up in red.

The LED 216-2 is a unit that, in a case where a jam occurs in the upper conveyance section 202-2 in the sheet feeding section 202, 203, or 204, notifies the operator of this state by lighting up in red. The LED 216-2 is also used as an information notification unit that issues a notification indicating information different from that regarding a jam. Specifically, in the system according to the present exemplary embodiment, the LED 216-2 is provided as a unit that presents information by lighting up in red also in a case where the escape tray 233 enters a trayful state where the escape tray 233 is full of sheets discharged onto the escape tray 233. Further, in the system according to the present exemplary embodiment, the LED 216-2 is provided to present information by lighting up in yellow also in a case where the escape tray 233 enters a state close to a trayful state.

The LED 216-3 is provided to present the remaining amounts of sheets in the trays 217, 218, and 219 included in the sheet feeding section 202, 203, or 204.

FIG. 3B is a diagram illustrating an example of the configuration of the image forming section 201. The alert light 212 has been described with reference to FIG. 1, and therefore is not described in detail. In the center of the image forming section 201, a head portion 234 is placed in which the inkjet heads and a control unit for the inkjet heads are placed. An ink tank control section 235 includes an information presentation portion that displays a method for replenishing ink, a method for replacing waste ink, and the remaining amounts of ink.

Each of the LEDs 216-4 and 216-5 is a unit that, in a case where a jam occurs in the upper conveyance section 201-2 in the image forming section 201, notifies the operator of this state by lighting up in red. The LED 216-6 is a unit that, in a case where a jam occurs in the lower conveyance section 201-3 in the image forming section 201, notifies the operator of this state by lighting up in red.

FIG. 3C is a diagram illustrating examples of the configurations of the first fixing section 205, the second fixing section 206, the cooling section 207, and the reverse section 208.

The reverse section 208 according to the present exemplary embodiment includes a turning module top tray 238 that discharges a sheet residing in the printer 102 in a case where an error occurs in the printer 102.

In the reverse section 208, in a case where a chart image is printed to adjust the tint of the printer 102, a sheet on which the chart image is printed is discharged to the turning module top tray 238.

In upper portions of the first fixing section 205 and the second fixing section 206, covers 236 and 237 are provided. Since the first fixing section 205 and the second fixing section 206 use the heaters to dry a sheet, the covers 236 and 237 are provided to prevent the operator or a person in charge of maintenance from inadvertently touching the heaters.

The LED 216-7 is a unit that, in a case where a jam occurs in the upper conveyance section 205-2 in the first fixing section 205, notifies the operator of this state by lighting up in red. The LED 216-8 is a unit that, in a case where a jam occurs in the lower conveyance section 205-3 in the first fixing section 205, notifies the operator of this state by lighting up in red.

The LED 216-9 is a unit that, in a case where a jam occurs in the upper conveyance section 206-2 in the second fixing section 206, notifies the operator of this state by lighting up in red. The LED 216-10 is a unit that, in a case where a jam occurs in the lower conveyance section 206-3 in the second fixing section 206, notifies the operator of this state by lighting up in red.

The LED 216-11 is a unit that, in a case where a jam occurs in the upper conveyance section 207-2 in the cooling section 207, notifies the operator of this state by lighting up in red. The LED 216-12 is a unit that, in a case where a jam occurs in the lower conveyance section 207-3 in the cooling section 207, notifies the operator of this state by lighting up in red.

The LED 216-13 is a unit that, in a case where a jam occurs in the upper conveyance section 208-2 in the reverse section 208, notifies the operator of this state by lighting up in red. In a case where sheets discharged to the turning module top tray 238 exceed a certain number of sheets, the LED 216-13 lights up in yellow or red according to the number of discharged sheets based on an instruction from the DFE 103.

The LED 216-14 is a unit that, in a case where a jam occurs in the lower conveyance section 208-3 in the reverse section 208, notifies the operator of this state by lighting up in red. The extinction and lighting and the lighting color of the LED 216-13 are determined as follows. Every time a sheet is discharged to the turning module top tray 238, the printer 102 notifies the DFE 103 of this state, and the DFE 103 holds and counts the number of stacked sheets. Consequently, a scheduler determines whether the turning module top tray 238 is full or near full. The details will be described below.

FIG. 3D is a diagram illustrating examples of the configurations of the sheet discharge sections 209, 210, and 211. Each of the sheet discharge sections 209, 210, and 211 according to the present exemplary embodiment includes two sheet discharge parts. Stacking portions 242-1 to 242-3 are portions used to stack a large number of sheets and are protected by doors 243-1 to 243-3, respectively. Stacker top trays 241-1 to 241-3 are trays for discharging a small amount of sheets and do not include doors.

To improve the properties of stacking sheets in the stacking portions 242-1 to 242-3, the stacking portions 242-1 to 242-3 have jogger (not illustrated) mechanisms inside. The printer 102 according to the present exemplary embodiment has a tray linking function capable of treating a plurality of stacking portions as a single sheet discharge destination in the case of a configuration including the plurality of sheet discharge sections 209, 210, and 211 as in the configuration illustrated in FIG. 1.

Sheet discharge buttons 239-1 to 239-3 are tray ejection instruction units and are instruction units used to discharge sheets stacked inside the doors 243-1 to 243-3 by unlocking the doors 243-1 to 243-3 and enabling access to the stacking portions 242-1 to 242-3 inside the doors 243-1 to 243-3, respectively.

Tray stacking amount notification units 240-1 to 240-3 are display units that notify the operator of the stacking amounts (the heights) of stacked sheets by stepwise display.

Tray operation units 250-1 to 250-3 are units that notify the operator of the statuses of the sheet discharge sections 209 to 211, respectively. In the tray operation unit 250-1, the tray stacking amount notification unit 240-1 indicates that sheets are discharged up to the number of sheets set in advance (or the stacking height calculated based on the sheet type). The sheet discharge button 239-1 is in the state where the sheet discharge button 239-1 indicates that it is necessary to remove sheets stacked in the stacking portion 242-1, by lighting up. A sheet discharge section warning 244-1 is a lamp that notifies the operator of an abnormality of the sheet discharge section 209. In a case where the lamp is in an extinguished state, this indicates that the sheet discharge section 209 can operate without any problem.

In the tray operation unit 250-2, the tray stacking amount notification unit 240-2 indicates that sheets do not reach the number of sheets set in advance (or the stacking height calculated based on the sheet type). The sheet discharge button 239-2 indicates that it is possible to stack more sheets in the stacking portion 242-2, and it is not necessary to remove already stacked sheets to continuously stack sheets, based on an extinguished state of a lamp. In a case where a sheet discharge section warning 244-2 lights up, this indicates that the sheet discharge section 210 is in an abnormal state. In this case, it is necessary to inspect the sheet discharge section 210 before continuing to discharge sheets to the sheet discharge section 210.

The LEDs 216-15, 216-16, and 216-17 are units that, in a case where jams occur in the upper conveyance sections 209-2 of the sheet discharge sections 209, 210, and 211, respectively, notify the operator of this state by lighting up in red. In a case where it is detected that the stacker top trays 241-1 to 241-3 included in the sheet discharge sections 209, 210, and 211 are full of sheets stacked in the stacker top trays 241-1 to 241-3, the LEDs 216-15, 216-16, and 216-17, respectively, notify the operator of this state by lighting up in red. Further, in a case where it is detected that the stacker top trays 241-1 to 241-3 included in the sheet discharge sections 209, 210, and 211 come close to the state where the stacker top trays 241-1 to 241-3 are full of sheets stacked in the stacker top trays 241-1 to 241-3, the LEDs 216-15 to 216-17, respectively, notify the operator of this state by lighting up in yellow.

The LEDs 216-18, 216-19, and 216-20 are units that, in a case where jams occur in the lower conveyance sections 209-3 of the sheet discharge sections 209, 210, and 211, respectively, notify the operator of this state by lighting up in red. Further, in a case where it is detected that the stacking portions 242-1 to 242-3 included in the sheet discharge sections 209, 210, and 211 are full of sheets stacked in the stacking portions 242-1 to 242-3, the LEDs 216-18, 216-19, and 216-20, respectively, notify the operator of this state by lighting up in red. In a case where it is detected that the stacking portions 242-1 to 242-3 included in the sheet discharge sections 209, 210, and 211 come close to the state where the stacking portions 242-1 to 242-3 are full of sheets stacked in the stacking portions 242-1 to 242-3, the LEDs 216-18, 216-19, and 216-20, respectively, notify the operator of this state by lighting up in yellow. The extinction and lighting and the lighting colors of the LEDs 216-15, 216-16, 216-17, 216-18, 216-19, and 216-20 are determined according to the full/near-full state of the sheet discharge destination of a sheet used in a print job generated by the scheduler.

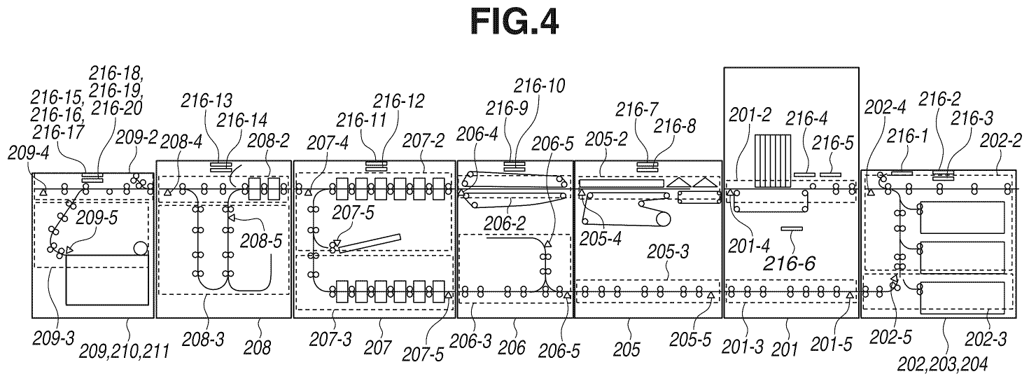

FIG. 4 is a diagram illustrating the forms of the conveyance sections of the modules included in the printer 102, the positional relationships between the sheet passage sensors of the modules, and the relations of the placement of the LEDs 216 of the modules.

The sheet feeding sections 202, 203, and 204 are described. Each of the sheet feeding sections 202, 203, and 204 includes the upper conveyance section 202-2 and the lower conveyance section 202-3, and the upper conveyance section 202-2 and the lower conveyance section 202-3 are placed as illustrated in FIG. 4. The conveyance sections 202-2 and 202-3 include the sheet passage sensors 202-4 and 202-5 in the upstream portions of the conveyance sections 202-2 and 202-3, respectively. In a case where a sheet is conveyed on the conveyance sections 202-2 and 202-3, the sheet passage sensors 202-4 and 202-5 detect that the sheet passes through the sheet passage sensors 202-4 and 202-5, respectively, and determine the presence or absence of a sheet. The sheet passage sensors 202-4 and 202-5 according to the present exemplary embodiment are used to detect the occurrence of a jam.

Specifically, the sheet passage sensors 202-4 and 202-5 detect the presence or absence of a jam by the following method. That is, according to an instruction from the CPU 224, the microprocessor included in each module such as the sheet feeding section 202, 203, or 204 controls the conveyance sections 202-2 and 202-3 to convey a sheet. The sheet is conveyed to the module, the conveyance sections 202-2 and 202-3 included in the module are controlled to convey the sheet, and the sheet is carried out of the module. At this time, the time required from when the sheet is conveyed to inside the module to when the sheet is conveyed to outside the module based on the relationships between the conveyance speed of the sheet and the shapes and the lengths of the conveyance sections 202-2 and 202-3 inside the module is an assumed in-apparatus residence time. If the sheet is detected by the sheet passage sensors 202-4 and 202-5 when the in-apparatus residence time elapses, it can be detected that the conveyance process is performed as assumed. However, if the sheet is not detected by the sheet passage sensors 202-4 and 202-5 even though the assumed in-apparatus residence time elapses, it can be determined that the sheet is not properly conveyed. That is, it is considered that a jam occurs and the conveyance process stagnates. Thus, the sheet passage sensors 202-4 and 202-5 determine whether the sheet is to be conveyed to outside the module at the time when the predetermined in-apparatus residence time regarding the sheet elapses. To this end, the sheet passage sensors 202-4 and 202-5 are placed in the upstream portions of the conveyance sections 202-2 and 202-3, respectively.

As illustrated in FIG. 3A, if it is detected that a jam occurs in the lower conveyance section 202-3, the LED 216-1 notifies the operator of this state by lighting up in red. If it is detected that a jam occurs in the upper conveyance section 202-2, the LED 216-2 notifies the operator of this state by lighting up in red.

The image forming section 201 is described. The image forming section 201 includes the upper conveyance section 201-2 and the lower conveyance section 201-3, and the upper conveyance section 201-2 and the lower conveyance section 201-3 are placed as illustrated in FIG. 4. The conveyance sections 201-2 and 201-3 include the sheet passage sensors 201-4 and 201-5 in the upstream portions of the conveyance sections 201-2 and 201-3, respectively. As illustrated in FIG. 3B, if it is detected that a jam occurs in the upper conveyance section 201-2, the LEDs 216-4 and 216-5 notify the operator of this state by lighting up in red. If it is detected that a jam occurs in the lower conveyance section 201-3, the LED 216-6 notifies the operator of this state by lighting up in red. The method for detecting a jam is equivalent to those in the sheet feeding sections 202, 203, and 204, and therefore is not described in detail.

The first fixing section 205 is described. The first fixing section 205 includes the upper conveyance section 205-2 and the lower conveyance section 205-3, and the upper conveyance section 205-2 and the lower conveyance section 205-3 are placed as illustrated in FIG. 4. The conveyance sections 205-2 and 205-3 include the sheet passage sensors 205-4 and 205-5 in the upstream portions of the conveyance sections 205-2 and 205-3, respectively. As illustrated in FIG. 3C, if it is detected that a jam occurs in the upper conveyance section 205-2, the LED 216-7 notifies the operator of this state by lighting up in red. If it is detected that a jam occurs in the lower conveyance section 205-3, the LED 216-8 notifies the operator of this state by lighting up in red. The method for detecting a jam is equivalent to those in the sheet feeding sections 202, 203, and 204, and therefore is not described in detail.

The second fixing section 206 is described. The second fixing section 206 includes the upper conveyance section 206-2 and the lower conveyance section 206-3, and the upper conveyance section 206-2 and the lower conveyance section 206-3 are placed as illustrated in FIG. 4. The conveyance sections 206-2 and 206-3 include the sheet passage sensors 206-4 and 206-5 in the upstream portions of the conveyance sections 206-2 and 206-3, respectively. As illustrated in FIG. 3C, if it is detected that a jam occurs in the upper conveyance section 206-2, the LED 216-9 notifies the operator of this state by lighting up in red. If it is detected that a jam occurs in the lower conveyance section 206-3, the LED 216-10 notifies the operator of this state by lighting up in red. The method for detecting a jam is equivalent to those in the sheet feeding sections 202, 203, and 204, and therefore is not described in detail.

The cooling section 207 is described. The cooling section 207 includes the upper conveyance section 207-2 and the lower conveyance section 207-3, and the upper conveyance section 207-2 and the lower conveyance section 207-3 are placed as illustrated in FIG. 4. The conveyance sections 207-2 and 207-3 include the sheet passage sensors 207-4 and 207-5 in the upstream portions of the conveyance sections 207-2 and 207-3, respectively. As illustrated in FIG. 3C, if it is detected that a jam occurs in the upper conveyance section 207-2, the LED 216-11 notifies the operator of this state by lighting up in red. If it is detected that a jam occurs in the lower conveyance section 207-3, the LED 216-12 notifies the operator of this state by lighting up in red. The method for detecting a jam is equivalent to those in the sheet feeding sections 202, 203, and 204, and therefore is not described in detail.

The reverse section 208 is described. The reverse section 208 includes the upper conveyance section 208-2 and the lower conveyance section 208-3, and the upper conveyance section 208-2 and the lower conveyance section 208-3 are placed as illustrated in FIG. 4. The conveyance sections 208-2 and 208-3 include the sheet passage sensors 208-4 and 208-5 in the upstream portions of the conveyance sections 208-2 and 208-3, respectively. As illustrated in FIG. 3C, if it is detected that a jam occurs in the upper conveyance section 208-2, the LED 216-13 notifies the operator of this state by lighting up in red. If it is detected that a jam occurs in the lower conveyance section 208-3, the LED 216-14 notifies the operator of this state by lighting up in red. The method for detecting a jam is equivalent to those in the sheet feeding sections 202, 203, and 204, and therefore is not described in detail.

The sheet discharge sections 209, 210, and 211 are described. Each of the sheet discharge sections 209, 210, and 211 includes the upper conveyance section 209-2 and the lower conveyance section 209-3, and the upper conveyance section 209-2 and the lower conveyance section 209-3 are placed as illustrated in FIG. 4. The conveyance sections 209-2 and 209-3 include the sheet passage sensors 209-4 and 209-5 in the upstream portions of the conveyance sections 209-2 and 209-3, respectively. As illustrated in FIG. 3D, if it is detected that a jam occurs in the upper conveyance section 209-2, the LED 216-15, 216-16, or 216-17 in the sheet discharge section 209, 210, or 211, respectively, including the conveyance section 209-2 in which the jam has been detected notifies the operator of this state by lighting up in red.

For example, if a jam is detected in only the conveyance section 209-2 included in the sheet discharge section 209, only the LED 216-15 lights up in red. If jams are detected in all the conveyance sections 209-2 included in the sheet discharge sections 209, 210, and 211, all the LED 216-15, 216-16, and 216-17 light up in red. If it is detected that a jam occurs in the lower conveyance section 209-3, the LED 216-18, 216-19, or 216-20 in the sheet discharge section 209, 210, or 211, respectively, including the conveyance section 209-3 in which the jam has been detected notifies the operator of this state by lighting up in red. For example, if a jam is detected in only the conveyance section 209-3 included in the sheet discharge section 209, only the LED 216-18 lights up in red. If jams are detected in all the conveyance sections 209-3 included in the sheet discharge sections 209, 210, and 211, all the LEDs 216-18, 216-19, and 216-20 light up in red. The method for detecting a jam is equivalent to those in the sheet feeding sections 202, 203, and 204, and therefore is not described in detail.

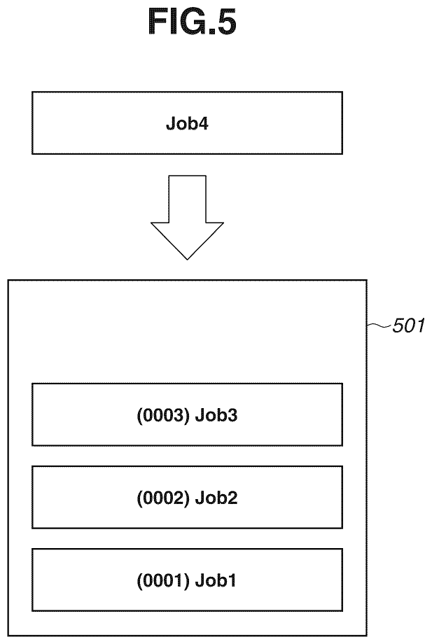

FIG. 5 illustrates the state where a scheduler program included in the DFE 103 stores print jobs received from the PC 105 via the network 100 in a queue 501 before the execution of the jobs. After the DFE 103 is powered on, the CPU 217 reads the scheduler program from the first SSD 221 into the first RAM 220 and executes the scheduler program. The scheduler program constantly monitors and analyzes the jobs stored in the queue 501 and instructs the operation section 222 to display the results of the analyses as schedule information.

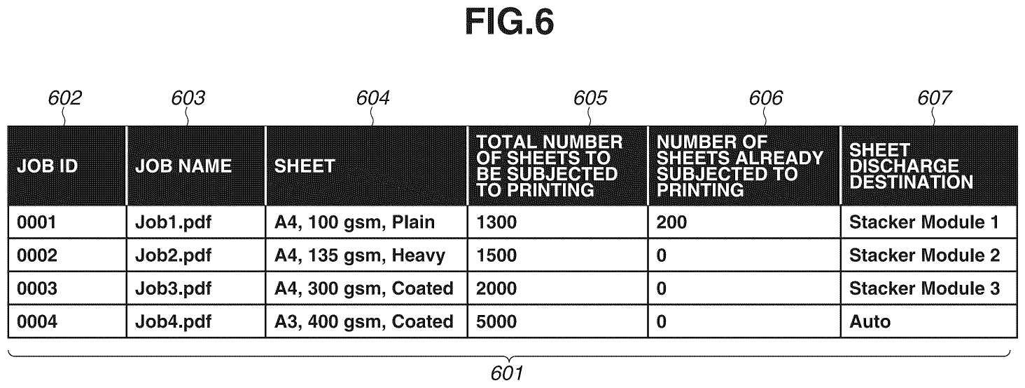

FIG. 6 illustrates a table in which the scheduler program stores the results of analyzing the print jobs stored in the queue 501. A table 601 is stored in the first RAM 220 and is updated by the scheduler program.

In the table 601, an item 602 indicates a job ID as the identifier of a print job. An item 603 indicates the job name of the print job. An item 604 indicates the type (the size, the grammage, and the surface property) of a sheet to be used in the print job.

An item 605 indicates the number of sheets to be used in the print job. For example, if one-sided printing is set for print data corresponding to 100 pages, 100 sheets are generated as a final print product. If two-sided printing is set for print data corresponding to 100 pages, since printing is performed on the front and back sides of each sheet, 50 sheets are generated as a final print product.

An item 606 indicates how many sheets are already subjected to printing in the print job and discharged to and stacked in a sheet discharge destination. An item 607 indicates the sheet discharge destination of the print job. If a particular sheet discharge destination is selected, then according to a condition for stacking sheets only in the selected sheet discharge destination, it is determined whether the selected sheet discharge destination is near full or full. If the “sheet discharge destination” 607 is set to “Auto”, a sheet discharge destination to which a sheet can be discharged is selected at the time of the start of printing, and a print sheet is discharged. Examples of a condition for selecting a sheet discharge destination to which a sheet can be discharged include the condition that the stacking of a sheet on an already stacked bundle of sheets does not influence the already stacked bundle of sheets. In a case where the tray linking function capable of treating a plurality of stacking portions as a single sheet discharge destination is enabled, and if a single sheet discharge destination is full, but a sheet can be discharged to another sheet discharge destination, the printing work is continued by switching the sheet discharge destinations. The scheduler program erases a job of which the printing is completed from the table 601.

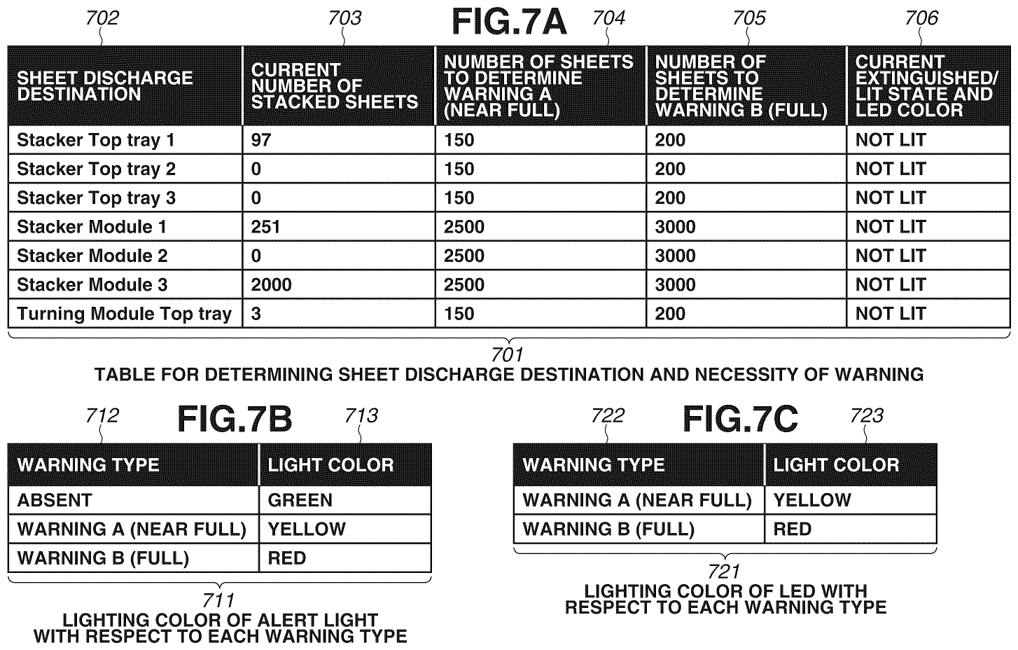

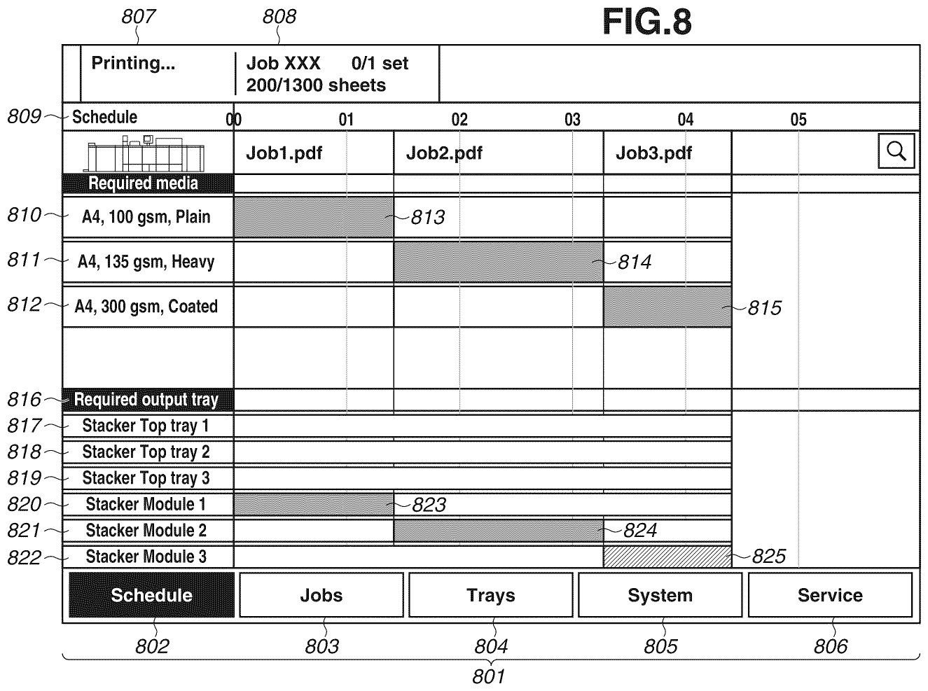

FIG. 7A illustrates a table that manages the current number of stacked sheets, warning conditions, the current extinction and lighting of an LED 216, and the lighting color of the LED 216 when the LED 216 lights up, with respect to each sheet discharge destination. A table 701 is stored in the first RAM 220 and updated by the scheduler program.

In the table 701, an item 702 indicates the sheet discharge destination of a sheet. An item 703 indicates how many sheets are stacked in the sheet discharge destination indicated by the item 702. An item 704 stores information regarding how many sheets are to be stacked in the sheet discharge destination indicated by the item 702 to determine that sheets will be fully stacked soon, i.e., the sheet discharge destination is in the near-full state. An item 705 stores information regarding how many sheets are to be stacked in the sheet discharge destination indicated by the item 702 to determine that sheets are fully stacked, i.e., the sheet discharge destination is in the full state where a sheet is not to be discharged to the sheet discharge destination unless sheets are removed from the sheet discharge destination. An item 706 stores information regarding the extinguished/lit state of the LED 216 included in the sheet discharge destination and the LED color of the LED 216 in a case where the LED 216 is in the lit state.

FIGS. 7B and 7C illustrate tables that manage light colors according to warning types regarding the alert light 212 and each LED 216. Tables 711 and 721 are stored in the first RAM 220 and referred to by the scheduler program. The table 711 is a table that manages a light color according to a warning type regarding the alert light 212. An item 712 indicates a warning type. An item 713 indicates a light color in which the alert light 212 is to be lit in the case of the warning indicated by the item 712.

The table 721 is a table that manages a light color according to a warning regarding each LED 216. An item 722 indicates a warning type. An item 723 indicates a light color in which the LED 216 is to be lit in the case of the warning indicated by the item 722.

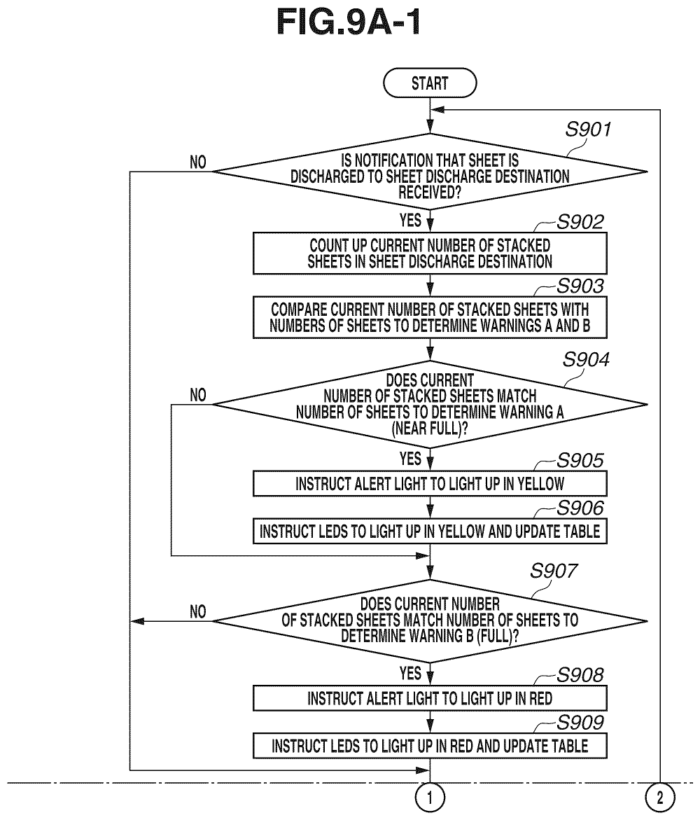

FIG. 8 illustrates an example of a schedule screen. A screen 801 is stored in the first SSD 221, and is read into the first RAM 220 by the scheduler program when the DFE 103 starts. Then, the scheduler program displays the screen 801 on the operation section 222 and updates the execution statuses of print jobs, where necessary.

A button 802 is used to display the printing statuses of print jobs. A button 803 is used to display print jobs held in the DFE 103. A button 804 is used to display the statuses of the sheet feeding devices. A button 805 is used to confirm and change the system settings of the DFE 103. A button 806 is used to confirm and change the service settings of the DFE 103.

The screen 801 is a schedule screen displayed when the button 802 is selected. The buttons 803 to 806 are portions that do not influence the present exemplary embodiment, and therefore are not described in detail.

An area 807 indicates the status of the printer 102 and indicates that printing is being performed. An area 808 indicates information regarding a print job that is being printed and the printing status of the print job. An area 809 displays the time axis of the printing schedule. “00” corresponds to the current status. The printing schedule is displayed in the direction of “01” and “02”.

An item 810 indicates that a print job “Job1.pdf” is being printed on sheets with a size “A4”, a grammage “100 gsm”, and a sheet type “Plain”. A schedule bar 813 indicates a printing time calculated by the scheduler program. The scheduler program calculates the number of sheets obtained by subtracting the number of sheets already subjected to printing from the total number of sheets to be subjected to printing in each job stored in the table 601. Then, the scheduler program multiplies the calculated number of sheets by a printing time required to print each sheet that is held in advance in the scheduler program, thereby calculating a printing time. Then, the scheduler program places schedule bars with the current time “00” as a starting point in the order of execution of the print jobs.

For example, suppose that the current state is the state where job IDs “0001” to “0003” are registered in the table 601. At this time, in a currently executed job having the job ID “0001”, the number of sheets already subjected to printing “200” is subtracted from the total number of sheets to be subjected to printing “1300”, whereby it is understood that 1100 more sheets are to be used. This value is multiplied by a printing time required per sheet “A4, 100 gsm, Plain” (not illustrated), thereby calculating a printing time. Then, a schedule bar having a length according to the calculated printing time is generated and displayed as the schedule bar 813 in the screen 801 on the operation section 222.

Also in the job ID “0002”, similar calculations are performed. Since a job having the job ID “0002” starts after the job having the job ID “0001”, a schedule bar 814 corresponding to the job ID “0002” is placed with a time after the scheduled end time of the schedule bar 813 as a starting point.

Also in the job ID “0003”, similar calculations are performed. A schedule bar 815 is placed with a time after the scheduled end time of the schedule bar 814 corresponding to the job ID “0002” as a starting point.

An item 816 indicates information regarding a sheet discharge destination used in a print job. Specifically, the top trays 241-1 to 241-3 included in the sheet discharge sections 209 to 211 are displayed as “Stacker Top tray 1” 817, “Stacker Top tray 2” 818, and “Stacker Top tray 3” 819, respectively.

Similarly, the stacking portions 242-1 to 242-3 included in the sheet discharge sections 209 to 211 are displayed as “Stacker Module 1” 820, “Stacker Module 2” 821, and “Stacker Module 3” 822, respectively.

The scheduler program receives a sheet discharge notification and a notification that a sheet is removed from a tray or a stacking portion that are issued by the printer 102. Then, the scheduler program manages information regarding the number of sheets stacked in each sheet discharge destination. Consequently, the scheduler program can calculate whether the printing is to end in the state where the sheet discharge destination has room or the sheet discharge destination reaches a state close to the full state after the execution of a print job, or the sheet discharge destination becomes full during the print job.

For example, a case is described where in each of the job IDs “0001” and “0002”, the printing is to end in the state where the sheet discharge destination has room even after the execution of the job according to the calculations. In this case, as illustrated in schedule bars 823 and 824, a schedule bar corresponding to the sheet discharge destination of each job is displayed in “green”, for example.

A case is described where in the job ID “0003”, the sheet discharge destination is to reach a state close to the full state after the execution of the print job, or is to become full during the print job according to the calculations. In this case, the color of a schedule bar is set to a color different from those of the schedule bars 823 and 824, such as “yellow”, and the schedule bar is displayed as a schedule bar 825.

As described above, the scheduler program displays the printing status of printing that is being executed or is to be executed and the statuses of a sheet and a sheet discharge destination to be used in a color-coded manner to the operator operating the operation section 222, thereby achieving intuitive job management.

Next, a case is described where the LEDs 216 of all the top trays 241-1 to 241-3 of the multiply connected stackers 209 to 211 or the inside of the stackers 209 to 211 all light up and go out in conjunction with each other.

FIGS. 9A-1 and 9A-2 illustrate a flowchart in which the DFE 103 controls the alert light 212 and the LEDs 216 according to the present exemplary embodiment. The processing of the flowchart of the DFE 103 is stored in the first SSD 221 and executed by the CPU 217. The flowchart of the DFE 103 starts by powering on the DFE 103. A control method for controlling the DFE 103 is described below.

In step S901, the CPU 217 determines whether a notification that a sheet is discharged to a sheet discharge destination is received from the printer 102. If a notification that a sheet is discharged is received (Yes in step S901), the processing proceeds to step S902. If a notification that a sheet is discharged is not received (No in step S901), the processing proceeds to step S910.

In step S902, the CPU 217 accesses the table 701 and counts up the “current number of stacked sheets” 703 in the sheet discharge destination indicated by the “sheet discharge destination” 702 regarding which the notification is received in step S901. That is, the CPU 217 functions as a counting section, and with respect to each of a plurality of sheet discharge destinations indicated by the “sheet discharge destination” 702, counts the “current number of stacked sheets” 703 regarding the sheet discharged to the sheet discharge destination indicated by the “sheet discharge destination” 702.

Then, the processing proceeds to step S903.

In step S903, the CPU 217 accesses the table 701 and compares the “current number of stacked sheets” 703 in the sheet discharge destination indicated by the “sheet discharge destination” 702 that is counted up in step S902 and the “number of sheets to determine warning A (near full)” 704. In this step, the CPU 217 determines whether the “current number of stacked sheets” 703 is less than the “number of sheets to determine warning A (near full)” 704, or matches the “number of sheets to determine warning A (near full)” 704, or exceeds the “number of sheets to determine warning A (near full)” 704. Then, the CPU 217 records the result of the determination in the first RAM 220. Then, the processing proceeds to step S904.

In step S904, the CPU 217 confirms the result of the determination recorded in step S903 in the first RAM 220. If the “current number of stacked sheets” 703 in the sheet discharge destination indicated by the “sheet discharge destination” 702 regarding which the sheet discharge notification is received is less than the “number of sheets to determine warning A (near full)” 704 or exceeds the “number of sheets to determine warning A (near full)” 704 (No in step S904), the processing proceeds to step S907.

In step S904, if the “current number of stacked sheets” 703 in the sheet discharge destination indicated by the “sheet discharge destination” 702 regarding which the sheet discharge notification is received reaches (matches) the “number of sheets to determine warning A (near full)” 704 (Yes in step S904), the processing proceeds to step S905. The “number of sheets to determine warning A (near full)” 704 is an example of a first threshold.

In step S905, the CPU 217 accesses the table 711 and acquires “yellow” in the light color 713 associated with “warning A (near full)” in the warning type 712.

Then, the CPU 217 controls the printer 102 to instruct the alert light 212 to light up in “yellow”. The alert light 212 is an example of a light-emitting device included in the image forming apparatus 101. Then, the processing proceeds to step S906.

In step S906, the CPU 217 accesses the table 721 and acquires “yellow” in the light color 723 associated with “warning A (near full)” in the warning type 722.

Then, the CPU 217 functions as a control section and controls the printer 102 to instruct the LED 216 included in the sheet discharge destination indicated by the “sheet discharge destination” 702 in which the “current number of stacked sheets” 703 reaches the “number of sheets to determine warning A (near full)” 704 to light up in “yellow”. The LED 216 is an example of a light-emitting device included in the sheet discharge destination indicated by the “sheet discharge destination” 702.

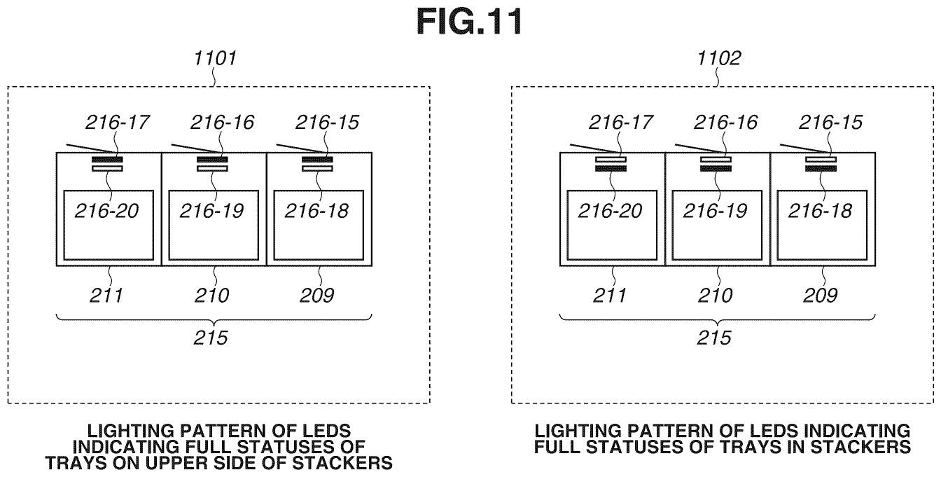

For example, if the sheet discharge destination is a stacker top tray, the CPU 217 instructs the LEDs 216 on the top tray side included in all the stackers 209 to 211 to light up in consideration of the visibility of the operator. More specifically, as illustrated in a portion 1101 in FIG. 11, all the LEDs 216-15, 216-16, and 216-17 on the upper side of the stackers 209, 210, and 211, respectively, enter the lit states.

If the sheet discharge destination is in a stacker, the CPU 217 instructs the LEDs 216 on the stacker side included in all the stackers 209 to 211 to light up. More specifically, as illustrated in a portion 1102 in FIG. 11, all the LEDs 216-18, 216-19, and 216-20 on the stacker side enter the lit states.

Then, the CPU 217 accesses the table 701 and updates the “current extinguished/lit state and LED color” 706 in the sheet discharge destination indicated by the “sheet discharge destination” 702 that is lit to “lit in yellow”. Specifically, a case is described where the CPU 217 brings all the LEDs 216-15, 216-16, and 216-17 on the upper side of the stackers 209, 210, and 211, respectively, into the lit states. In this case, the CPU 217 updates all the “current extinguished/lit state and LED color” 706 in “Stacker Top Tray 1” to “Stacker Top Tray 3” indicated by the “sheet discharge destination” 702 in the table 701 to “yellow”.

A case is also described where the CPU 217 brings all the LEDs 216-18, 216-19, and 216-20 inside the stackers 209, 210, and 211, respectively, into the lit states. In this case, the CPU 217 updates all the “current extinguished/lit state and LED color” 706 in “Stacker Top Module 1” to “Stacker Top Module 3” indicated by the “sheet discharge destination” 702 in the table 701 to “yellow”. Then, the processing proceeds to step S907.

In step S907, the CPU 217 confirms the result of the determination recorded in step S903 in the first RAM 220. If the “current number of stacked sheets” 703 in the sheet discharge destination indicated by the “sheet discharge destination” 702 regarding which the sheet discharge notification is received is less than the “number of sheets to determine warning B (full)” 705 (No in step S907), the processing proceeds to step S910.

In step S907, if the “current number of stacked sheets” 703 in the sheet discharge destination indicated by the “sheet discharge destination” 702 regarding which the sheet discharge notification is received reaches (matches) the “number of sheets to determine warning B (full)” 705 (Yes in step S907), the processing proceeds to step S908. The “number of sheets to determine warning B (full)” 705 is an example of a second threshold and is the number of sheets different from the “number of sheets to determine warning A (near full)” 704.

In step S908, the CPU 217 accesses the table 711 and acquires “red” in the light color 713 associated with “warning B (full)” in the warning type 712. Then, the CPU 217 controls the printer 102 to instruct the alert light 212 to light up in “red”. Then, the processing proceeds to step S909.

Although an example has been described where the alert light 212 and the LEDs 216 are instructed to light up in yellow in steps S905 and S906, and the alert light 212 and the LEDs 216 are instructed to light up in red in steps S908 and S909, some embodiments are not limited to this. The alert light 212 and the LEDs 216 may be instructed to light up in other colors.

Alternatively, the alert light 212 and the LEDs 216 may be instructed to light up in other forms other than colors. In steps S905 and S906, the CPU 217 controls the alert light 212 and the LEDs 216 to light up in a first form. In steps S908 and S909, the CPU 217 controls the alert light 212 and the LEDs 216 to light up in a second form different from the first form. The first and second forms may be differentiated from each other by blinking instead of colors. Although an example has been described where the color of the alert light 212 and the color of the LEDs 216 are the same as each other, the color of the alert light 212 and the color of the LEDs 216 may be different colors.

In step S909, the CPU 217 accesses the table 721 and acquires “red” in the light color 723 associated with “warning B (full)” in the warning type 722. Then, the CPU 217 controls the printer 102 to instruct the LED 216 included in the sheet discharge destination indicated by the “sheet discharge destination” 702 in which the “current number of stacked sheets” 703 reaches the “number of sheets to determine warning B (full)” 705 to light up in “red”. Also in this case, as described in step S906, if the sheet discharge destination is a stacker top tray, the CPU 217 instructs the LEDs 216 on the top tray side included in all the stackers 209 to 211 to light up in consideration of the visibility of the operator. If the sheet discharge destination is on the stacker side, the CPU 217 instructs the LEDs 216 on the stacker side included in all the stackers 209 to 211 to light up.

Then, the CPU 217 accesses the table 701 and updates the “current extinguished/lit state and LED color” 706 in the sheet discharge destination indicated by the “sheet discharge destination” 702 that is lit to “lit in red”. Then, the processing proceeds to step S910.

In step S910, the CPU 217 determines whether a notification that a stacked object (a sheet) in a sheet discharge destination is removed is received from the printer 102. If a notification that a stacked object is removed is received (Yes in step S910), the processing proceeds to step S911. If a notification that a stacked object is removed is not received (No in step S910), the processing returns to step S901.

In step S911, the CPU 217 determines whether a sheet discharge destination other than the sheet discharge destination regarding which the notification that the stacked object is removed is received in step S910 is in the near-full or full state.

For example, a case is described where the sheet discharge destination from which the stacked object is removed in step S910 is “Stacker Module 1”. In this case, by the calculation method described in step S903, the CPU 217 calculates and determines whether the stacking states of “Stacker Module 2” and “Stacker Module 3” in which the LEDs 216 are lit in conjunction with “Stacker Module 1” are in the near-full or full states.

If at least one sheet discharge destination in the near-full or full state is present (Yes in step S911), the CPU 217 records this state in the first RAM 220, and the processing proceeds to step S912.

In step S912, the CPU 217 confirms the presence or absence of a sheet discharge destination in the full state. If it is confirmed that a sheet discharge destination in the full state is present, the CPU 217 performs a process similar to that of step S909. Further, if the sheet discharge destination in the full state is in a stacker, the CPU 217 notifies the printer 102 of this state. If it is confirmed that a sheet discharge destination in the full state is not present, and a sheet discharge destination in the near-full state is present, the CPU 217 performs a process similar to that of step S906. Then, the processing proceeds to step S914.

In step S911, if a sheet discharge destination in the near-full or full state is not present (No in step S911), the processing proceeds to step S913.

In step S913, the CPU 217 controls the printer 102 to instruct the LED 216 included in the sheet discharge destination regarding which the notification that the stacked object is removed is received in step S910 and the LEDs 216 in the other sheet discharge destinations lit in conjunction with the sheet discharge destination to go out.

The CPU 217 also resets the “current number of stacked sheets” 703 in the sheet discharge destination indicated by the “sheet discharge destination” 702 from which the stacked object is removed in the table 701. Then, the processing proceeds to step S914.

In step S914, the CPU 217 accesses the table 701 and determines the presence or absence of a sheet discharge destination in which the LED 216 is in the lit state. If at least one sheet discharge destination in which the LED 216 is in the lit state is present (Yes in step S914), the processing returns to step S901. If a sheet discharge destination in which the LED 216 is in the lit state is not present (No in step S914), the processing proceeds to step S915.

In step S915, the CPU 217 determines whether a problem occurs in an apparatus related to the lighting of the alert light 212 other than the sheet discharge destinations. If a problem occurs in an apparatus related to the lighting of the alert light 212 other than the sheet discharge destinations (Yes in step S915), the processing returns to step S901. If a problem does not occur in an apparatus related to the lighting of the alert light 212 other than the sheet discharge destinations (No in step S915), the processing proceeds to step S916.

In step S916, the CPU 217 accesses the table 711 and acquires “green” in the light color 713 associated with “absent” in the warning type 712. Then, the CPU 217 controls the printer 102 to instruct the alert light 212 to light up in “green”.

Then, the processing returns to step S901.

As described at the beginning of the description, the flowchart in FIGS. 9A-1 and 9A-2 starts by powering on the DFE 103. Then, the flowchart continues to be executed by the CPU 217 until the DFE 103 is powered off.

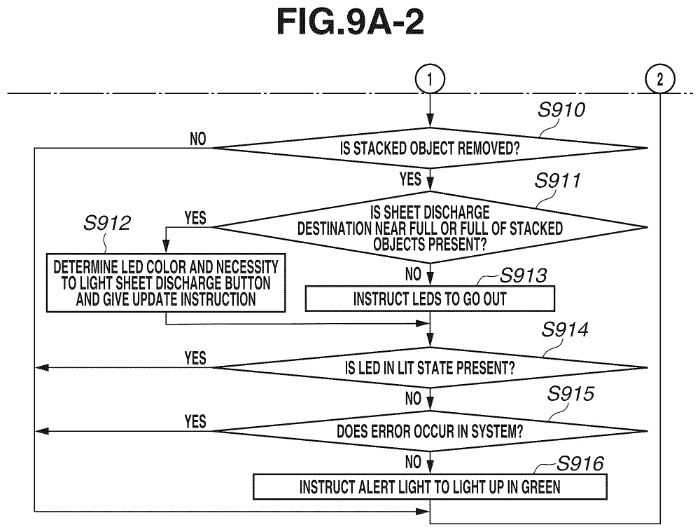

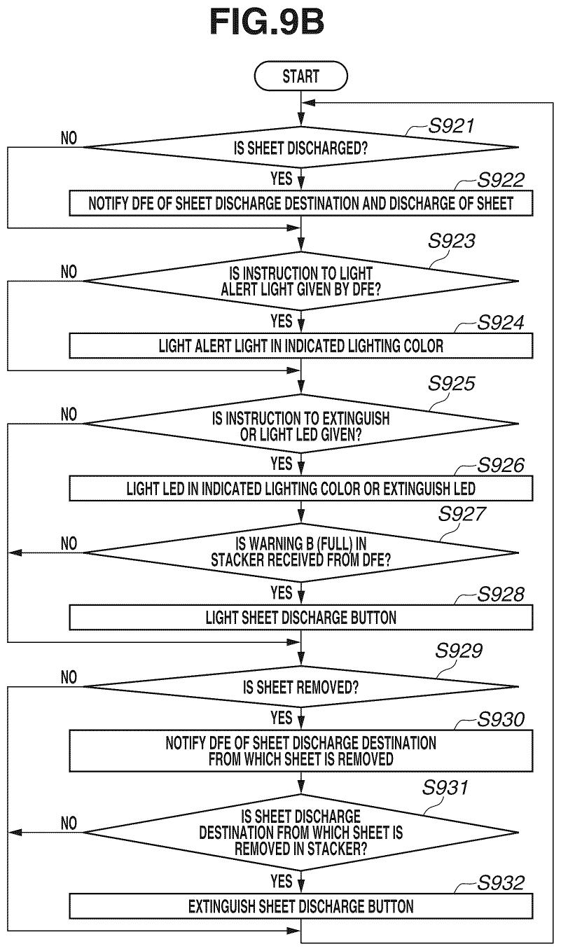

FIG. 9B illustrates a flowchart in which the printer 102 controls the alert light 212, the LEDs 216, and the lights of the sheet discharge buttons 239-1 to 239-3 included in the stackers 209 to 211, respectively, according to the present exemplary embodiment. The processing of the flowchart of the printer 102 is stored in the second SSD 230 and executed by the CPU 224. The flowchart of the printer 102 starts by powering on the printer 102. A control method for controlling the printer 102 is described below.

In step S921, the CPU 224 determines whether a notification that a print sheet is discharged is received via a sheet discharge sensor in a sheet discharge destination included in the printer 102. If a notification that a sheet is discharged is not received (No in step S921), the processing proceeds to step S923. If a notification that a sheet is discharged is received (Yes in step S921), the processing proceeds to step S922.

In step S922, the CPU 224 transmits to the DFE 103 a notification indicating the sheet discharge destination regarding which the notification that the sheet is discharged is received in step S921, and regarding the discharge of the sheet. Then, the processing proceeds to step S923.

In step S923, the CPU 224 determines whether an instruction to light the alert light 212 is given by the DFE 103. If an instruction to light the alert light 212 is not given by the DFE 103 (No in step S923), the processing proceeds to step S925. If an instruction to light the alert light 212 is given by the DFE 103 (Yes in step S923), the processing proceeds to step S924.

In step S924, the CPU 224 confirms a lighting color indicated by the DFE 103 in step S923 and lights the alert light 212 in the indicated lighting color. Then, the processing proceeds to step S925.

In step S925, the CPU 224 determines whether an instruction to extinguish or light an LED 216 is given by the DFE 103. If an instruction to extinguish or light an LED 216 is not given by the DFE 103 (No in step S925), the processing proceeds to step S929. If an instruction to extinguish or light an LED 216 is given by the DFE 103 (Yes in step S925), the processing proceeds to step S926.

In step S926, if the instruction is an extinction instruction, the CPU 224 extinguishes the LED 216 included in a sheet discharge destination regarding which the extinction instruction is given. In step S926, if the instruction is a lighting instruction, the CPU 224 confirms a lighting color indicated by the DFE 103 in step S925 and lights the LED 216 in the indicated lighting color. Then, the processing proceeds to step S927.

In step S927, the CPU 224 determines whether an instruction to light the LED 216 in red to indicate “warning B (full)” in a sheet discharge destination in a stacker is received from the DFE 103. If an instruction to light the LED 216 in red to indicating “warning B (full)” in a sheet discharge destination in a stacker is not received from the DFE 103 (No in step S927), the processing proceeds to step S929. If an instruction to light the LED 216 in red to indicate “warning B (full)” in a sheet discharge destination in a stacker is received from the DFE 103 (Yes in step S927), the processing proceeds to step S928.

In step S928, the CPU 224 controls the sheet discharge button 239 included in the stacker corresponding to “warning B (full)” regarding which the lighting instruction is received in step S927 to light up as illustrated in the sheet discharge button 239-1 in FIG. 3D. Then, the processing proceeds to step S929.

In step S929, the CPU 224 determines whether a notification that a sheet is removed from a sheet discharge destination is received from any of the sheet discharge sections 209 to 211. If a notification that a sheet is removed is not received (No in step S929), the processing returns to step S921. If a notification that a sheet is removed is received (Yes in step S929), the processing proceeds to step S930.

In step S930, the CPU 224 transmits to the DFE 103 a notification indicating the sheet discharge destination from which the sheet is removed in step S929. Then, the processing proceeds to step S931.

In step S931, the CPU 224 determines whether the sheet discharge destination from which the sheet is removed in step S929 is in the stacker. If the sheet discharge destination is not in the stacker (No in step S931), the processing returns to step S921. If the sheet discharge destination from which the sheet is removed is in the stacker (Yes in step S931), the processing proceeds to step S932.

In step S932, the CPU 224 controls the sheet discharge button 239 included in the stacker determined in step S931 to go out as illustrated in the sheet discharge button 239-2 in FIG. 3D. Then, the processing returns to step S921.

As described at the beginning of the description, the flowchart in FIG. 9B starts by powering on the printer 102. Then, the flowchart continues to be executed by the CPU 224 until the printer 102 is powered off.

Next, a case is described where if the tray linking function is enabled, the LEDs 216 are lit according to a warning in the final sheet discharge destination.

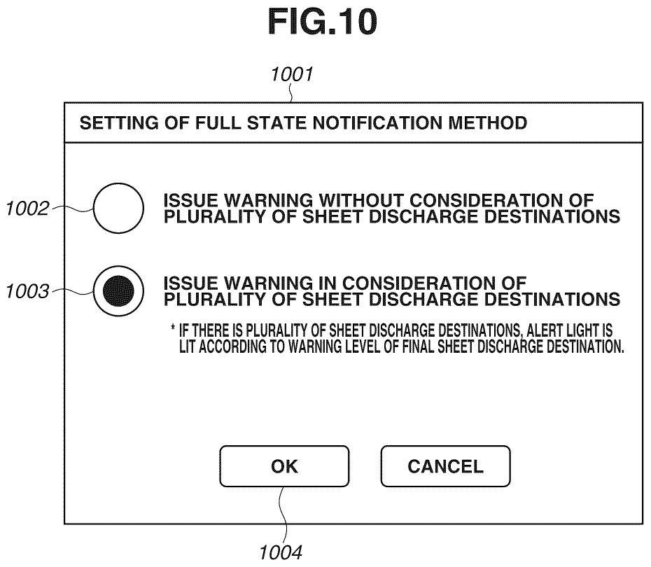

A description is given of a method for lighting the LEDs 216 in a case where the tray linking function capable of treating a plurality of stacking portions as a single sheet discharge destination is enabled. A screen 1001 in FIG. 10 is a screen for setting whether to light the LEDs 216 by determining whether a sheet discharge destination is near full or full in consideration of a plurality of sheet discharge destinations in a case where the tray linking function is enabled.

The operator displays the screen 1001 on the operation section 222 by operating the operation section 222 in FIG. 2A, selects “issue warning without consideration of plurality of sheet discharge destinations” 1003 using a radio button by operating the operation section 222, and presses an OK button 1004. As a result, the CPU 217 records this setting in the first RAM 220.

If this setting is enabled, for example, regarding “0004” indicated by the job ID 602 in which a printing execution instruction is given with “Auto” in the “sheet discharge destination” 607 in the table 601, a sheet discharge destination to which a sheet can be discharged is selected at the start of the execution of the printing, and the printing starts.

On this screen, it is desirable that as the sheet discharge destination to which a sheet can be discharged, a sheet discharge destination in a stacker closest to a print module (PM) is selected. The print module is a module that includes ink heads and places ink on a sheet. Further, in a case where the tray linking function is enabled, and if another stacker to which a sheet can be discharged is present, and even if the sheet discharge destination of a sheet that is being discharged enters the full state, another stacker to which a sheet can be discharged is automatically selected, and the printing is continued.

Also in this case, the DFE 103 controls the LEDs 216 to go out and light up according to the flowchart illustrated in FIGS. 9A-1 and 9A-2. However, after step S902, the DFE 103 switches sheet discharge destinations and confirms the presence or absence of a stacker that enables the continuation of the printing. If a stacker that enables the continuation of the printing is present, the processing does not proceed to step S903, and the processing proceeds to step S910. If a stacker that enables the continuation of the printing is not present, it is determined that the current sheet discharge destination is the final sheet discharge destination among the sheet discharge destinations treated as a single sheet discharge destination, and the processing proceeds to step S903.

If the “current number of stacked sheets” 703 regarding the sheet discharged to a sheet discharge destination indicated by the “sheet discharge destination” 702 to which the sheet is being discharged reaches the “number of sheets to determine warning A (near full)” 704, and another stacker to which a sheet can be discharged is present, the CPU 217 does not control the LED 216 included in the sheet discharge destination indicated by the “sheet discharge destination” 702 to light up.

If the “current number of stacked sheets” 703 regarding the sheet discharged to a sheet discharge destination indicated by the “sheet discharge destination” 702 to which the sheet is being discharged reaches the “number of sheets to determine warning A (near full)” 704, and another stacker to which a sheet can be discharged is not present, the CPU 217 controls the LED 216 included in the sheet discharge destination indicated by the “sheet discharge destination” 702 to light up.

As described above, in a case where the tray linking function is enabled, the LEDs 216 can be lit for the first time at the timing when it is detected that all enabled sheet discharge destinations are in the full states. In this manner, the operator can determine whether the current state is the state where work is really necessary.

Next, the discharge of a sheet to the turning module top tray 238 is described. As illustrated in the table 701, also for the turning module top tray 238, similarly to the other sheet discharge destinations, information regarding the “current number of stacked sheets” 703, the “number of sheets to determine warning A (near full)” 704, the “number of sheets to determine warning B (full)” 705, and the “current extinguished/lit state and LED color” 706 is provided. This sheet discharge destination, however, is provided as a sheet discharge destination in the function of discharging a sheet on which a chart for adjusting the tint of the printer 102 is printed, or the function of detecting the deformation of a fed sheet and discharging the sheet to outside the printer 102. Thus, this sheet discharge destination is not specified as a sheet discharge destination in a normal print job. Thus, information regarding the turning module top tray 238 is not illustrated on the schedule screen, either. If, however, these sheets are fully stacked in the turning module top tray 238, the printing cannot be continued. Thus, an LED 216 is provided in the turning module top tray 238, thereby notifying the operator of the near-full or full state.

As described above, according to the present exemplary embodiment, it is possible to mount LEDs 216 indicating the statuses of the remaining amounts of sheets on the sheet discharge sections 209 to 211, and in a case where the sheet discharge sections 209 to 211 are close to the state where the sheet discharge sections 209 to 211 are full of sheets, notify the operator of this state by lighting the LEDs 216. Thus, it is possible to provide an image forming apparatus 101 that is convenient and efficient. In this manner, a user can determine whether it is necessary to take out a final product, without going to the operation section 222. Thus, it is possible to efficiently use the image forming apparatus 101.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-085521, which was filed on May 27, 2024 and which is hereby incorporated by reference herein in its entirety.

What is claimed is:

1. An image forming system comprising:
a plurality of sheet discharge apparatuses, each including at least one light-emitting section; and
a control unit configured to, under a condition that the number of sheets discharged to a certain sheet discharge apparatus among the plurality of sheet discharge apparatuses reaches a threshold, control the at least one light-emitting section included in each of the plurality of sheet discharge apparatuses to light up.

2. The image forming system according to claim 1,
wherein in a case where the number of sheets discharged to the certain sheet discharge apparatus reaches the threshold, the control unit controls the at least one light-emitting section included in the sheet discharge apparatus in which the number of sheets discharged to the certain sheet discharge apparatus reaches the threshold to light up in a first form, and
wherein in a case where the number of sheets discharged to the certain sheet discharge apparatus reaches another threshold different from the threshold, the control unit controls the at least one light-emitting section included in the sheet discharge apparatus in which the number of sheets discharged to the sheet discharge apparatus reaches another threshold to light up in a second form different from the first form.

3. The image forming system according to claim 2,
wherein the first form is a first color, and
wherein the second form is a second color different from the first color.

4. The image forming system according to claim 2,
wherein in a case where the number of sheets discharged to the certain sheet discharge apparatus reaches a first threshold, the control unit controls the light-emitting section included in the sheet discharge apparatus in which the number of sheets discharged to the certain sheet discharge apparatus reaches the first threshold to light up in the first form, and controls a light-emitting section included in the image forming apparatus to light up in a third form, and
wherein in a case where the number of sheets discharged to the certain sheet discharge apparatus reaches another threshold different from the first threshold, the control unit controls the light-emitting section included in the sheet discharge apparatus in which the number of sheets discharged to the certain sheet discharge apparatus reaches another threshold to light up in a second form different from the first form, and controls the light-emitting section included in the image forming apparatus to light up in a fourth form.

5. The image forming system according to claim 4,
wherein the first form is a first color,
wherein the second form is a second color different from the first color,
wherein the third form is a third color, and
wherein the fourth form is a fourth color different from the third color.

6. The image forming system according to claim 5,
wherein the third color is the same as the first color, and
wherein the fourth color is the same as the second color.

7. The image forming system according to claim 2, wherein in a case where the number of sheets discharged to the certain sheet discharge apparatus reaches another threshold, and a sheet discharge destination in which the number of sheets discharged to the certain sheet discharge apparatus reaches another threshold is in a stacker, the control unit controls a sheet discharge button included in the stacker to light up.

8. The image forming system according to claim 7, wherein after the control unit controls the sheet discharge button included in the stacker to light up, and in a case where a sheet in the stacker is removed, the control unit controls the sheet discharge button included in the stacker to go out.

9. The image forming system according to claim 1, wherein after the control unit controls the at least one light-emitting section included in the sheet discharge apparatus in which the number of sheets discharged to the certain sheet discharge apparatus reaches the threshold to light up, and in a case where a sheet in the sheet discharge apparatus in which the number of sheets discharged to the certain sheet discharge apparatus reaches the threshold is removed, the control unit controls the light-emitting section included in the sheet discharge apparatus from which the sheet is removed to go out.

10. The image forming system according to claim 9, further comprising a counting unit configured to count the number of sheets discharged to the certain sheet discharge apparatus among the plurality of sheet discharge apparatuses, each including the at least one light-emitting section.

11. The image forming system according to claim 1, wherein in a case where the number of sheets discharged to the certain sheet discharge apparatus reaches the threshold, the control unit controls a light-emitting section included in the sheet discharge apparatus in which the number of sheets discharged to the certain sheet discharge apparatus reaches the threshold to light up, and controls a light-emitting section included in the image forming apparatus to light up.

12. The image forming system according to claim 1,
wherein in a case where the number of sheets discharged to a sheet discharge apparatus to which a sheet is being discharged reaches the threshold, and another sheet discharge apparatus to which a sheet can be discharged is present, the control unit controls a light-emitting section included in the certain sheet discharge apparatus not to light up, and
wherein in a case where the number of sheets discharged to a sheet discharge apparatus to which a sheet is being discharged reaches the threshold, and another sheet discharge apparatus to which a sheet can be discharged is not present, the control unit controls the light-emitting section included in the certain sheet discharge apparatus to light up.

13. The image forming system according to claim 1, wherein the light-emitting section is a light-emitting diode (LED).

14. A control method for controlling an image forming system, the control method comprising:
determining whether the number of sheets discharged to a certain sheet discharge apparatus among a plurality of sheet discharge apparatuses, each including at least one light-emitting section, reaches a threshold; and
under a condition that the number of sheets discharged to the certain sheet discharge apparatus reaches the threshold according to the determination, controlling the at least one light-emitting section included in each of the plurality of sheet discharge apparatuses to light up.

15. A non-transitory computer-readable medium storing computer-executable instructions for causing a computer to execute a control method for controlling an image forming system, the control method comprising:
determining whether the number of sheets discharged to a certain sheet discharge apparatus among a plurality of sheet discharge apparatuses, each including at least one light-emitting section, reaches a threshold; and
under a condition that the number of sheets discharged to the certain sheet discharge apparatus reaches the threshold according to the determination, controlling the at least one light-emitting section included in each of the plurality of sheet discharge apparatuses to light up.
